(19) United States
(12) Patent Application Publication
(10) Pub. No.: US 2026/0272032 A1
(43) Pub. Date: Sep. 17, 2026

(54) AEROSOL GENERATING DEVICE AND MICROWAVE HEATING ASSEMBLY

(71) Applicant: SMOORE INTERNATIONAL HOLDINGS LIMITED, George Town (KY)

(72) Inventors: Jianbo HE, Shenzhen (CN); Jing DU, Shenzhen (CN); Kunren YIN, Shenzhen (CN); Feng LIANG, Shenzhen (CN)

(73) Assignee: SMOORE INTERNATIONAL HOLDINGS LIMITED, George Town (KY)

(21) Appl. No.: 19/679,302

(22) Filed: May 15, 2026

Related U.S. Application Data
(63) Continuation of application No. PCT/CN2024/124438, filed on Oct. 12, 2024.

(30) Foreign Application Priority Data
Nov. 15, 2023 (CN) 202311527504.4

(51) Int. Cl. A24F 40/46; A24F 40/20

(52) U.S. Cl. CPC A24F 40/46; A24F 40/20

(57) ABSTRACT

A microwave heating assembly includes: an inner conductor unit; and an outer conductor unit having a closed end, an open end opposite the closed end, and an accommodating cavity formed between the closed end and the open end, an accommodating region for accommodating an aerosol generating product being formed inside the accommodating cavity, the accommodating cavity having a first direction and a second direction that are perpendicular to an axial direction of the aerosol generating product, the first direction being perpendicular to the second direction. Two convex edges protrude toward the accommodating region are arranged on an inner surface of the outer conductor unit. The two convex edges extend in a direction from the closed end to the open end. The inner conductor unit is at least partially mounted inside the accommodating cavity and includes a microwave radiation structure.

### FIELD

The present invention relates to the field of atomization, and in particular, to an aerosol generating device and a microwave heating assembly.

### BACKGROUND

At present, most of aerosol generating device related products on the market still rely on traditional heating methods such as conduction and radiation for heating. Microwaves, as a more efficient and three-dimensional heating method with less thermal inertia, have enormous potential for development in the art. To use microwaves to heat an aerosol generating product, it is necessary to match a small-size cavity and a high-density energy field. The distribution of the energy field inside the cavity in the related technology is usually designed improperly. This can easily lead to a poor heating effect on the aerosol generating product in the cavity, such as a low aerosol output speed or local burning of the aerosol generating product.

### SUMMARY

In an embodiment, the present invention provides a microwave heating assembly, comprising: an inner conductor unit; and an outer conductor unit comprising a closed end, an open end opposite the closed end, and an accommodating cavity formed between the closed end and the open end, an accommodating region configured to accommodate an aerosol generating product being formed inside the accommodating cavity, the accommodating cavity having a first direction and a second direction that are perpendicular to an axial direction of the aerosol generating product, the first direction being perpendicular to the second direction, wherein two convex edges protruding toward the accommodating region are arranged on an inner surface of the outer conductor unit, the two convex edges extending in a direction from the closed end to the open end, wherein the inner conductor unit is at least partially mounted inside the accommodating cavity and comprises a microwave radiation structure, wherein, in the first direction, the microwave radiation structure is located on a same side of the accommodating region as the two convex edges, wherein, in the second direction, the microwave radiation structure is located between the two convex edges, and wherein a minimum distance between the two convex edges on the two opposite sides of the microwave radiation structure in the second direction is less than a length of the accommodating region in the second direction.

### BRIEF DESCRIPTION OF THE DRAWINGS

To describe the technical solutions in the embodiments of this application more clearly, the following briefly introduces the accompanying drawings for describing the embodiments or the exemplary technology Apparently, the accompanying drawings in the following description show merely some embodiments of this application, and a person of ordinary skill in the art may still derive other drawings from the accompanying drawings without creative efforts.

FIG. 1 is a schematic diagram of a partial structure of an aerosol generating device in a first embodiment of the present invention;

FIG. 2 is a schematic diagram of another view of the partial structure of the aerosol generating device shown in FIG. 1;

FIG. 3 is a cross-sectional view of the partial structure of the aerosol generating device shown in FIG. 1;

FIG. 4 is a schematic diagram of a structure of a fixing member in the aerosol generating device shown in FIG. 1;

FIG. 5 is a diagram of distribution of an energy field of the aerosol generating device shown in FIG. 1;

FIG. 6 is a schematic partially enlarged diagram of the distribution of the energy field of the aerosol generating device shown in FIG. 5;

FIG. 7 is a diagram of a distribution of an energy field when a distance D1 between two convex ridges in an aerosol generating device is less than or equal to 80% of the length D2 of an accommodating region in a second direction;

FIG. 8 is a schematic diagram of a structure of an aerosol generating device in a second embodiment of the present invention;

FIG. 9 is a cross-sectional view of the aerosol generating device shown in FIG. 1;

FIG. 10 is a diagram of distribution of an energy field of the aerosol generating device shown in FIG. 1;

FIG. 11 is a schematic partially enlarged diagram of the distribution of the energy field of the aerosol generating device shown in FIG. 1;

FIG. 12 is a diagram of distribution of an energy field of a conventional aerosol generating device;

FIG. 13 is a schematic partially enlarged diagram of distribution of an energy field of a conventional aerosol generating device; and

FIG. 14 is a schematic diagram of a structure of an aerosol generating device in a third embodiment of the present invention.

### DETAILED DESCRIPTION

In an embodiment, the present invention provides an improved aerosol generating device and a microwave heating assembly.

Technical solutions adopted in the present invention to solve the technical problem are as follows: The present invention provides a microwave heating assembly, including an inner conductor unit and an outer conductor unit.

The outer conductor unit includes a closed end, an open end opposite to the closed end, and an accommodating cavity formed between the closed end and the open end. An accommodating region for accommodating an aerosol generating product is formed inside the accommodating cavity. The accommodating cavity includes a first direction and a second direction that are perpendicular to the axial direction of the aerosol generating product. The first direction is perpendicular to the second direction.

Two convex edges protruding toward the accommodating region are arranged on the inner surface of the outer conductor unit. The convex edges extend in a direction from the closed end to the open end.

The inner conductor unit is at least partially mounted inside the accommodating cavity and includes a microwave radiation structure. In the first direction, the microwave radiation structure is located on the same side of the accommodating region as the two convex edges. In the second direction, the microwave radiation structure is located between the two convex edges. A minimum distance between the two convex edges on the two opposite sides of the microwave radiation structure in the second direction is less than the length of the accommodating region in the second direction.

In some embodiments, the convex edges extend from the closed end to the open end to a position opposite to the accommodating region, or extend from a position that is away from the closed end by a set distance toward the open end to the position opposite to the accommodating region.

In some embodiments, a maximum distance between the two convex edges in the second direction is less than or equal to the length of the accommodating region in the second direction.

The maximum distance between the two convex edges in the second direction is less than or equal to 80% of the length of the accommodating region in the second direction.

In some embodiments, the accommodating cavity includes a first chamber for accommodating the aerosol generating product, and a second chamber communicated with the first chamber.

The convex edges are located on the inner surface of the first chamber.

In some embodiments, the outer conductor unit includes a first side wall and a second side wall that are axially connected to each other. The first side wall defines the first chamber. The second side wall defines the second chamber.

The inner conductor unit extends from the second chamber to the first chamber.

A microwave feeding hole is formed in the second side wall. The microwave feeding hole is communicated with the second chamber of the accommodating cavity.

In some embodiments, the inner surface of the outer conductor unit is partially recessed to form a groove. The groove has a notch facing the inner conductor unit. The two convex ridges are formed at the two opposite edges of the notch.

In some embodiments, the outer conductor unit at least includes a first cartridge and a second cartridge that are spliced and communicated with each other. The cross-sectional size of the first cartridge is greater than or equal to the cross-sectional size of the second cartridge. The axis of the first cartridge is parallel to the axis of the second cartridge.

The convex ridges are formed at spliced positions of the first cartridge and the second cartridge.

In some embodiments, the inner conductor unit includes a microwave matching structure.

The microwave matching structure is disposed within the accommodating cavity, is in ohmic contact with the closed end, and extends toward the open end.

The microwave radiation structure is spaced apart from the microwave matching structure and is in ohmic contact with the closed end.

Alternatively, the microwave matching structure is disposed within the accommodating cavity, is in ohmic contact with the closed end, and is coaxially connected to and integrally formed with the microwave radiation structure.

In some embodiments, the microwave heating assembly further includes a fixing member. The fixing member is disposed within the accommodating cavity and is located at the open end.

The fixing member is barrel-shaped. A receiving cavity for receiving the aerosol generating product is formed in the fixing member. The accommodating region is formed inside the receiving cavity.

The fixing member includes a cylindrical wall. A gap is provided on one side of the cylindrical wall facing the convex edges. An edge of the gap resists against the inner surface of the outer conductor unit.

An accommodating slot for accommodating at least a part of the microwave radiation structure is provided on the cylindrical wall and is located on the inner side of the gap.

An aerosol generating device is further provided, including the microwave heating assembly, a microwave feeding unit connected to the inner conductor unit of the microwave heating assembly, and a microwave generating unit connected to the microwave feeding unit.

The implementation of the aerosol generating device and the microwave heating assembly of the present invention has the following beneficial effects: In the microwave heating assembly, the two convex edges protruding toward the accommodating region are arranged on the inner surface of the outer conductor unit, and each convex edge extends in the direction from the closed end to the open end. Furthermore, in the first direction, the microwave radiation structure is located on the same side of the accommodating region as the two convex edges. In the second direction, the microwave radiation structure is located between the two convex edges. The minimum distance between the two convex edges on the two opposite sides of the microwave radiation structure in the second direction is less than the length of the accommodating region in the second direction. Therefore, the distribution of an energy field of the accommodating cavity can be adjusted through the two convex edges to achieve energy field optimization, to ensure the centralization of an overall energy field and the uniformity of a local field. Thus, it can optimize the aerosol volume while ensuring the aerosol output speed.

It should be further noted that, unless otherwise clearly specified and limited, terms such as "connected", "connection", and "arranged" should be understood in a generalized manner, for example, connection may be a fixed connection, a detachable connection, or integration, or may be a mechanical connection or an electrical connection, or may be a direct connection, an indirect connection via an intermediate, an internal communication of two elements, or an interaction relationship between two elements. When an element is referred to as being "above" or "below" another element, the element can be "directly" or "indirectly" located above the another element, or one or more intervening elements may exist. The terms "first", "second", and the like are merely for ease of describing the technical solutions, and should not be understood as indicating or implying relative importance or implicitly specifying the number of indicated technical features. Therefore, a feature limited by "first", "second", and the like may explicitly or implicitly include one or more of the features. A person of ordinary skill in the art may understand the specific meanings of the foregoing terms in this application according to specific situations.

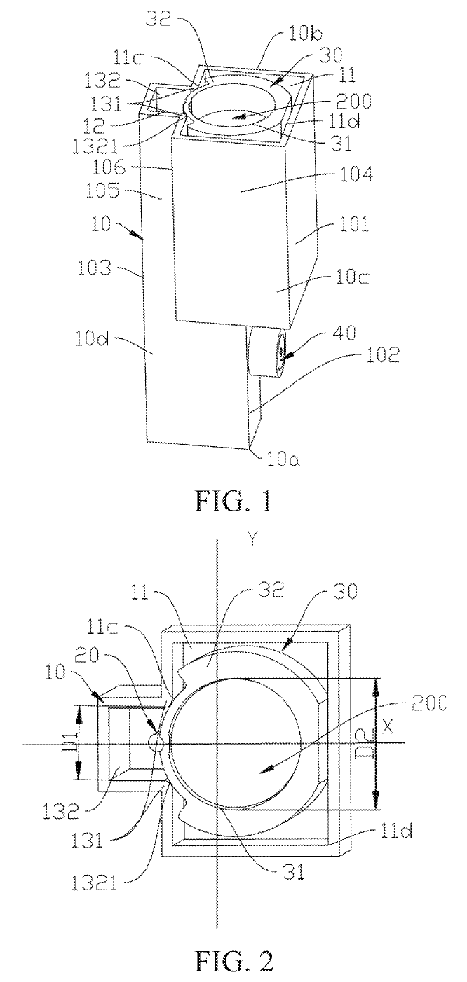

FIG. 1 shows a first embodiment of an aerosol generating device of the present invention. The aerosol generating device can heat an aerosol generating product 200 by feeding microwaves, to generate aerosols for user inhalation. The aerosol generating product 200 is separably disposed within the aerosol generating device. In some embodiments, the aerosol generating product 200 is columnar. Specifically, the aerosol generating product 200 may be cylindrical and may be a strip-shaped, particulate, or sheet-like solid material made of leaves, flowers, and/or stems of a plant, and the solid material may be further added with an aroma component.

As shown in FIG. 1, in this embodiment, the aerosol generating device may include a shell (not shown), a microwave heating assembly, and a microwave generating unit (not shown). The microwave heating assembly is received within the shell (not shown) and is configured to: generate microwaves inside after being connected to a microwave generator and form an energy field, thereby heating the aerosol generating product 200. The microwave generating unit (not shown) can be connected to the microwave heating assembly and is configured to feed the microwaves.

In this embodiment, the microwave heating assembly may include an outer conductor unit 10 and an inner conductor unit 20. The inner conductor unit 20 is at least partially disposed within the outer conductor unit 10, and can feed the microwaves into the outer conductor unit 10, so that the energy field can be generated inside the outer conductor unit 10.

As shown in FIG. 1 to FIG. 3, in this embodiment, the outer conductor unit 10 is made of a metal or other high-conductivity materials to confine the microwaves within it. In some embodiments, the outer conductor unit 10 is of a barrel-shaped structure, which may be in a regular shape, such as a cuboid shape or a cylindrical shape. In some embodiments, the outer conductor unit 10 may be in an irregular shape. Specifically, in this embodiment, the outer conductor unit 10 is in an irregular shape formed by partial outward protrusion or inward recessing.

In this embodiment, the outer conductor unit 10 may include a closed end 10a and an open end 10b. The closed end 10a and the open end 10b are opposite to each other in the axial direction. The open end 10b can be configured to load the aerosol generating product 200.

In this embodiment, the outer conductor unit 10 at least includes a first side wall 101, a second side wall 102, and a third side wall 103. The first side wall 101 and the second side wall 102 are axially connected to each other, are non-coaxial, and are arranged in a stepped manner. The third side wall 103 is opposite to both the first side wall 101 and the second side wall 102. In this embodiment, the outer conductor unit 10 may further include two opposite fourth side walls 104, two opposite fifth side walls 105, and two opposite sixth side walls 106. The two fourth side walls 104 are respectively located on the two opposite sides of the first side wall 101 and are connected to the first side wall 101. The two fifth side walls 105 are respectively located on the two opposite sides of the second side wall 102 and are respectively connected to the second side wall 102. The two sixth side walls 106 are respectively located on the two opposite sides of the fifth side walls 105, and each sixth side wall 106 is bent and connected to the fifth side walls 105, and is connected to the fourth side walls 104.

In this embodiment, the outer conductor unit 10 further includes a first cartridge 10c and a second cartridge 10d. The first cartridge 10c and the second cartridge 10d are spliced and communicated with each other. The axis of the first cartridge 10c and the axis of the second cartridge 10d are parallel to each other. The cross sections of the first cartridge 10c and the second cartridge 10d may be roughly square. It can be understood that in some other embodiments, the cross sections of the first cartridge 10c and the second cartridge 10d are not limited to being square and may be circular, semi-circular, or in other shapes. The cross-sectional size of the first cartridge 10c may be greater than the cross-sectional size of the second cartridge 10d, and the depth of the first cartridge 10c may be less than the depth of the second cartridge 10d. In some other embodiments, the cross-sectional size of the first cartridge 10c may be equal to the cross-sectional size of the second cartridge 10d. The first cartridge 10c may be enclosed by the first side wall 101, the fourth side walls 104, and the sixth side walls 106 that are connected to each other. The second cartridge 10d may be enclosed by the second side wall 102, the third side wall 103, and the fifth side walls 105 that are connected to each other.

In this embodiment, the inner side of the outer conductor unit 10 is hollowed to form an accommodating cavity 11, that is, the first cartridge 10c and the second cartridge 10d are spliced to define the accommodating cavity 11. The accommodating cavity 11 is located between the closed end 10a and the open end 10b, and may accommodate at least a part of the inner conductor unit 20 for microwave feeding. An accommodating region 310 is formed on the inner side of the accommodating cavity 11. The accommodating region 310 can be configured to accommodate the aerosol generating product 200. The closed end 10a and the open end 10b are formed in the axial direction of the accommodating cavity 11. The outer conductor unit 10 further has an opening 12 communicated with the accommodating cavity 11 and an end wall 14. The opening 12 is opposite to the end wall 14. In some embodiments, the opening 12 may be covered with a cover structure. The opening 12 correspondingly forms the open end 10b of the outer conductor unit 10b, and the end wall 14 correspondingly forms the closed end 10a of the outer conductor unit 10b.

In this embodiment, the accommodating cavity 11 further includes a first chamber 11a and a second chamber 11b. The first chamber 11a and the second chamber 11b are axially connected to each other and are communicated with each other. That is, the first chamber 11a is located at one end of the second chamber 11b. The open end 10b is formed at one end of the first chamber 11a. The closed end 10a is formed at one end of the second chamber 11b. The first chamber 11a may be defined by the first side wall 101, the fourth side walls 104, the sixth side walls 106, and a part of the third side wall 103. The second chamber 11b may be defined by the second side wall 102, the fifth side walls 105, and a part of the third side wall 103.

In this embodiment, the accommodating cavity 11 at least has a first direction and a second direction, both of which are perpendicular to the assembling direction of the aerosol generating product 200. The first direction and the second direction are perpendicular to each other. The first direction may be an X-axis direction, and the second direction may be a Y-axis direction. There are two sides in the first direction, such as a first side 11c and a second side 11d. The first side 11c and the second side 11d are opposite each other.

In this embodiment, at least two convex edges 131 are arranged on the inner surface of the outer conductor unit 10. Specifically, two convex edges 131 are provided.

In the first direction, the two convex edges 131 are located on the same side of the accommodating region 310 and each convex edge 131 protrudes toward the accommodating region 310. For example, the convex ridges 131 may be located on the first side 11c and protrude toward the accommodating region 310, or may be located on the second side 11d and protrude toward the accommodating region 310, thereby achieving protrusion toward the heated aerosol generating product 200. The inner surface of the outer conductor unit 10 implements a deformation design through the at least two convex edges 131. Furthermore, by arranging the at least two convex edges 131, it is convenient to adjust the distribution of the energy field inside the accommodating cavity 11 and compress the energy field. Specifically, centralization and local uniformity of the distribution of the energy field can be optimized, thereby ensuring the centralization of an overall field and the uniformity of a local field. The aerosol output speed can be ensured while optimizing the aerosol volume; local burning of the aerosol generating product 200 can be prevented; and the flavor of generated aerosols can be enhanced.

In some embodiments, the convex edges 131 may be of pointed structures and extend from in a direction from the closed end 10a to the open end 10b. Specifically, the convex ridges may extend from the closed end 10a to the open end 10b to a position opposite the accommodating region 310, specifically to the open end 10b. In some other embodiments, the convex edges 131 may extend from a position that is away from the closed end 10a by a set distance toward the open end 10b to the position opposite to the accommodating region 310. The convex edges 131 can be configured to adjust the energy field. Specifically, the convex edges 131 can play a role in gathering charges, to strengthen an electric field at this location, thereby causing the energy field to be gathered in the axial direction of the accommodating cavity 11 uniformly.

Specifically, the inner surface of the outer conductor unit 10 is partially recessed to form a groove 132. Specifically, the third side wall 103 of the outer conductor unit 10 opposite to the first side wall 101 is inwards recessed to form a second cartridge 10d, thus forming the groove 132 defined by the second cartridge 10d. The groove 132 has a notch 1321 facing the inner conductor unit 20. The notch 1321 faces the first cartridge 10c. The two opposite edges of the notch 1321 are located at spliced positions of the first cartridge 10c and the second cartridge 10d, to correspondingly form the two convex edges 131. That is, the convex edges 131 can be formed at the bends between the fifth side walls 105 and the sixth side walls 106. It can be understood that in some other embodiments, the convex edges 131 are not limited to being formed by inwards recessing of a part of the interior of the outer conductor unit 10.

In this embodiment, the inner conductor unit 20 is at least partially disposed within the accommodating cavity 11 and can be connected to the outer conductor unit 10 to introduce microwaves generated by a microwave generating unit into the accommodating cavity 11. In this embodiment, the inner conductor unit 20 is located inside the second cartridge 10d and can extend from the second chamber 11b to the first chamber 11a. It may include a microwave radiation structure 21 and a microwave matching structure 22. The microwave radiation structure 21 extends from the second chamber 11b to the first chamber 11a. One end of the microwave radiation structure 21 is in ohmic contact with the closed end 10a of the outer conductor unit 10, and the other end extending in the axial direction of the outer conductor unit 10, to form a free end. Specifically, in some embodiments, the microwave radiation structure 21 may be inserted into the end wall 14, while in some other embodiments, the microwave radiation structure 21 may directly resist against the end wall 14. The microwave radiation structure 21 may be a solid columnar body and may extend from the end wall 14 toward the opening 12. The microwave matching structure 22 is located in the outer conductor unit 10. The microwave matching structure 22 is specifically located inside the second chamber 11b and is spaced apart from the microwave radiation structure 21. The microwave matching structure 22 may be in ohmic contact with the closed end 10a. Specifically, in this embodiment, one end of the microwave matching structure 22 is plugged into the end wall 14, and the other end extends in the axial direction of the second chamber 11b, to form a free end. In some other embodiments, the microwave matching structure 22 may resist against the end wall 14. In some embodiments, the microwave matching structure 22 may be columnar or in a shape formed by combining two other stereo structures (such as a shape formed by splicing a cuboid shape with a columnar shape). The microwave matching structure 22 may be a magnetic coupling or electric coupling structure, or other structures that can achieve microwave matching. It can be configured to couple microwave energy into the accommodating cavity 11.

In this embodiment, in the first direction, the microwave radiation structure 21 and the two convex edges 131 are located on the same side of the accommodating region 310, and in the second direction, the microwave radiation structure 21 is located between the two convex edges 131. A minimum distance between the two convex edges 131 located on the two opposite sides of the microwave radiation structure 21 in the second direction is less than the length of the accommodating region 310 in the second direction, and a maximum distance D1 between the two convex edges 131 in the second direction is less than or equal to the length D2 of the accommodating region 310 in the second direction. The shape and size of the accommodating region 310 can be adapted to the shape and size of the cross section of the heated aerosol generating product 200 When the aerosol generating product 200 is cylindrical, the length D2 of the accommodating region 310 in the second direction is equal to the diameter of the heated aerosol generating product 200. When the aerosol generating product 200 is non-cylindrical, for example, when the cross section is square or rectangular, the length D2 of the accommodating region 310 in the second direction is equal to the length or width of the aerosol generating product 200 in the second direction. Optionally, in some embodiments, the maximum distance D1 between the two convex edges 131 is less than or equal to 80% of the length D2 of the accommodating region 310 in the second direction. In this ratio, a focused energy field can be ensured to be relatively uniform.

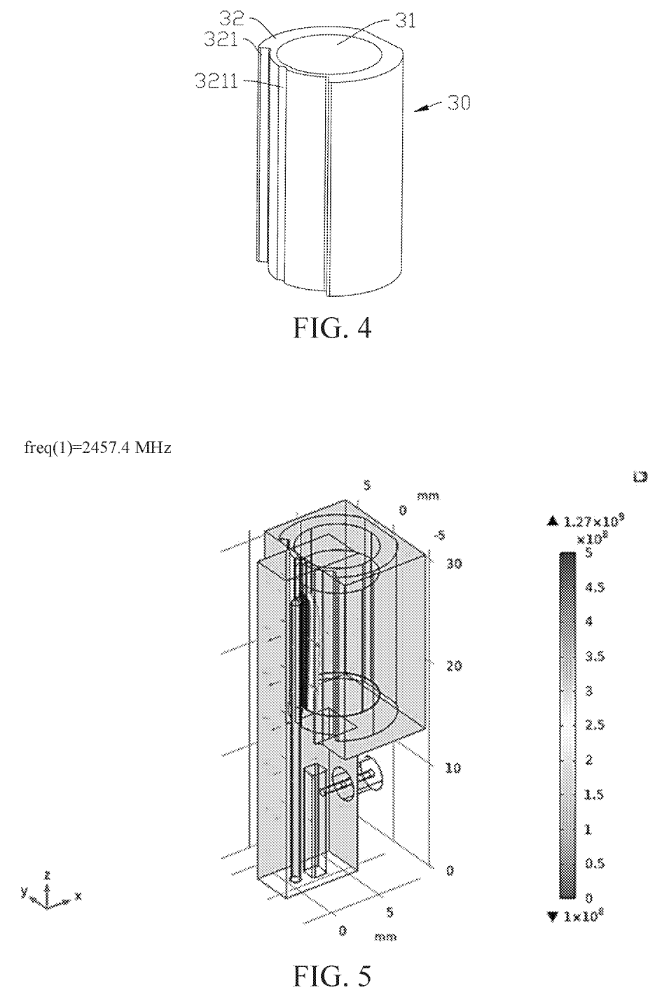

As shown in FIG. 4, in this embodiment, the microwave heating assembly may include a fixing member 30. The fixing member 30 is disposed within the accommodating cavity 11 and is located at the open end 10b, to fix the aerosol generating product 200. In this embodiment, the outer conductor unit 10 further includes a support wall 15. The support wall 15 can be located between the first chamber 11a and the second chamber 11b, and is connected to the first side wall 101 and the second side wall 102. The fixing member 30 is located on the support wall 15. The support wall 15 is parallel to the end wall 14, and a set distance is reserved between them. In some other embodiments, the support wall 15 can be omitted, and the fixing member 30 can be directly placed on the end wall 14. In this embodiment, the fixing member 30 is roughly barrel-shaped and is of a hollow structure with one end opened. A receiving cavity 31 may be formed in the inner side of the fixing member 31. The receiving cavity 31 is located inside the first chamber 11a, and the accommodating region 310 is formed in the receiving cavity 31. The shape and size of the cross section of the accommodating region 310 may be adapted to the shape and size of the cross section of the receiving cavity 31, that is, the receiving cavity 31 may be in tight fit with the aerosol generating product 200. The cross section of the receiving cavity 31 can be roughly circular. The receiving cavity 31 can be configured to receive the aerosol generating product 200. In this embodiment, the inner diameter of the receiving cavity 31 can be adapted to the outer diameter of the aerosol generating product 200. In some other embodiments, the cross-sectional size of the accommodating region 310 may be less than the cross-sectional size of the receiving cavity 31. In some embodiments, the fixing member 30 may include a cylindrical wall 32, and a gap 321 may be formed in one side of the cylindrical wall 32, facing the convex edges 131, of the accommodating cavity, that is, the gap 321 faces the first direction 11c and faces away from the second side 11d. An edge of the gap 321 resists against the inner surface of the outer conductor unit 10 and is located on one sides of the convex edges 131 facing away from the groove 132. The microwave radiation structure 21 may be arranged on the outer side of the cylindrical wall 32 and may be at least partially disposed within the gap 321. An accommodating slot 3211 is provided in the cylindrical wall 32. The accommodating slot 3211 may extend in the axial direction of the fixing member 32 and is located on the inner side of the gap 321. The cross section of the accommodating slot may be roughly circular to accommodate a part of the microwave radiation structure 21.

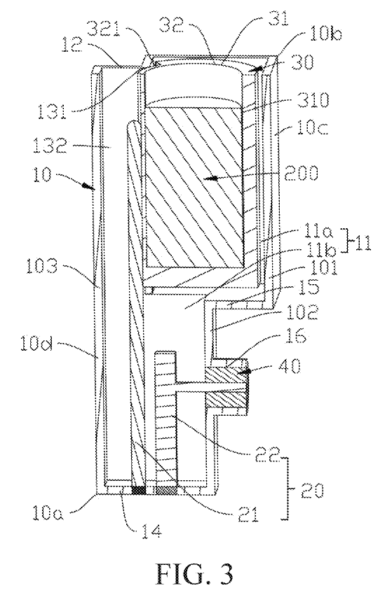

As shown in FIG. 3 and FIG. 4, in this embodiment, the aerosol generating device further includes a microwave feeding unit 40. The microwave feeding unit 40 is mounted on the outer conductor unit 10. Specifically, the microwave feeding unit 40 is embedded into the side wall of the outer conductor unit 10. Specifically, a feeding hole 16 may be formed in the side wall of the outer conductor unit 10. The microwave feeding unit 40 may be mounted inside the feeding hole 16, partially inserted into the accommodating cavity 11, and connected to the inner conductor unit 20. Furthermore, the microwave feeding unit 40 is also connected to the microwave generating unit (not shown). In this embodiment, the microwave feeding unit 40 may be connected to the microwave matching structure 22 and connected to the microwave generating unit (not shown) through a coaxial joint or microstrip line, to feed microwaves generated by the microwave generating unit (not shown) into the accommodating cavity 11 through the inner conductor unit 20. In some embodiments, the microwave feeding unit 40 may be made of a metal material, preferably metal aluminum or copper. Further, the outer surface of the microwave feeding unit may be coated with a silver or gold coating.

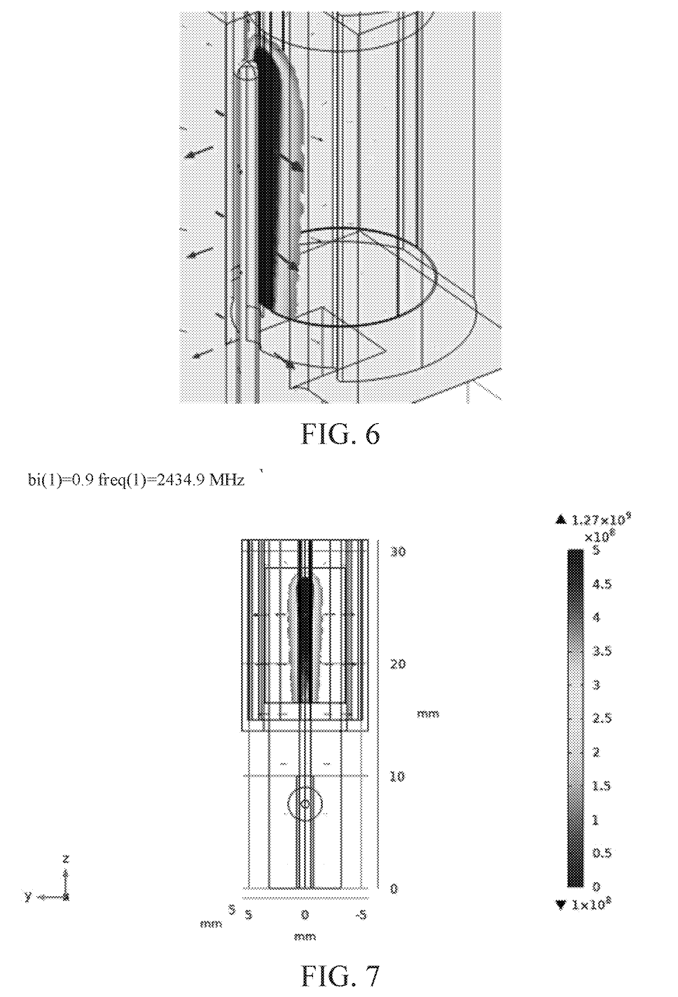

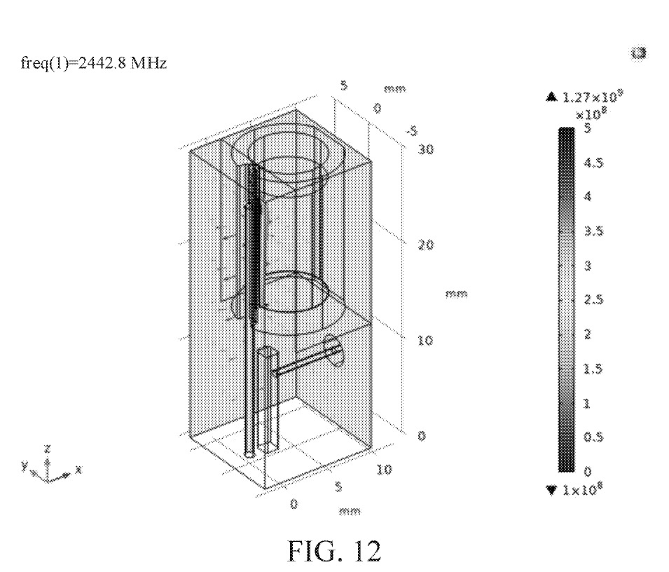

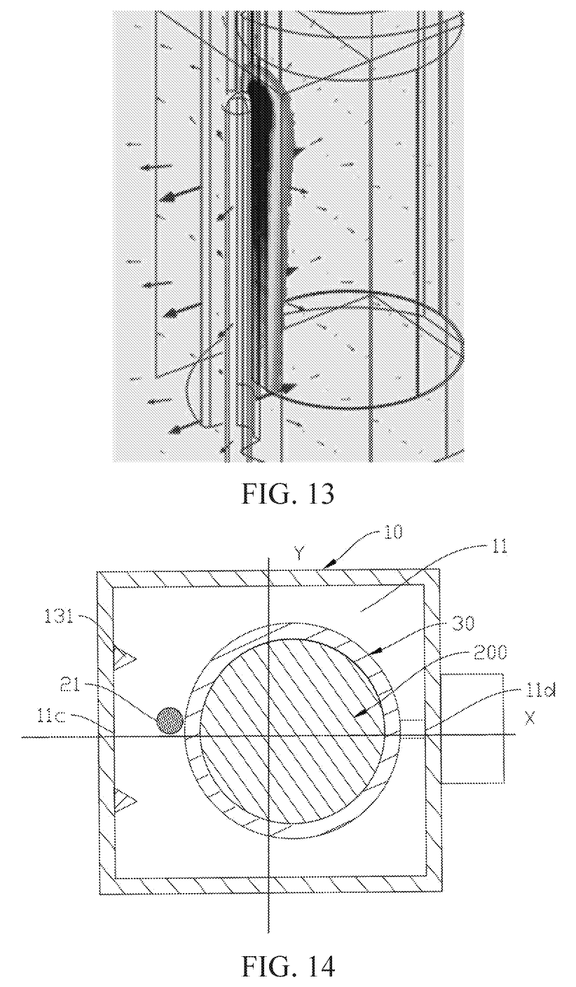

As shown in FIG. 5, FIG. 6, FIG. 12, and FIG. 13, compared with a conventional aerosol generating device, the aerosol generating device in this embodiment can centralize, in a particular region, the energy field inside the accommodating cavity 11 by arranging the at least two convex edges 131 on the inner surface of the accommodating cavity 11, and the distribution of the energy in the region is more uniform in the axial direction.

As shown in FIG. 2 and FIG. 7, when the distance D1 between the two convex edges in the aerosol generating device is set to be less than or equal to 80% of the diameter D2 of the aerosol generating product 200, the energy field inside the accommodating cavity 11 is centralized in a particular region, and the distribution of the energy in the region is more uniform in the axial direction.

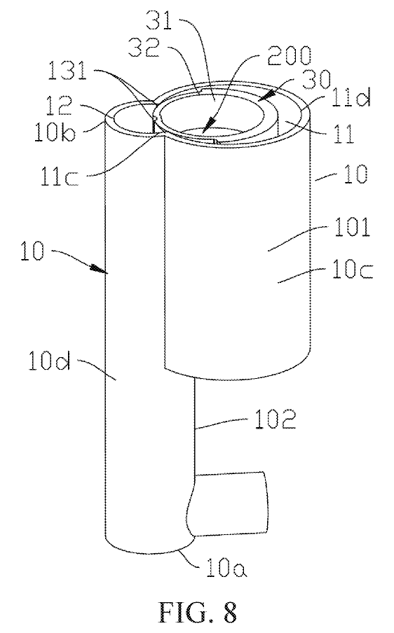

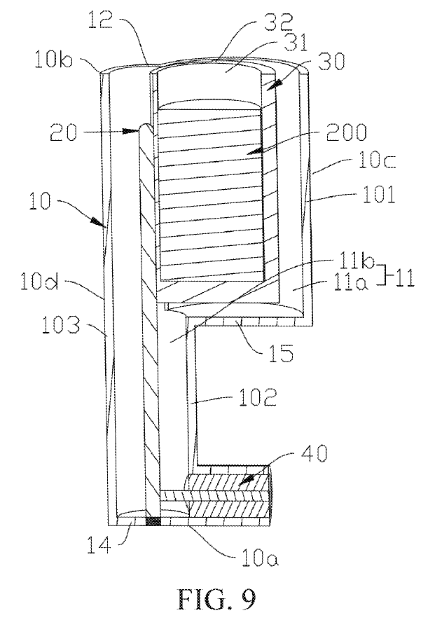

FIG. 8 to FIG. 9 show a second embodiment of an aerosol generating device of the present invention, which differs from the first embodiment in that the outer conductor unit 10 may be composed of a first cartridge 10c and a second cartridge 11d that have circular cross sections. The microwave matching structure 22 and the microwave radiation structure 21 are coaxially connected and integrally formed with each other.

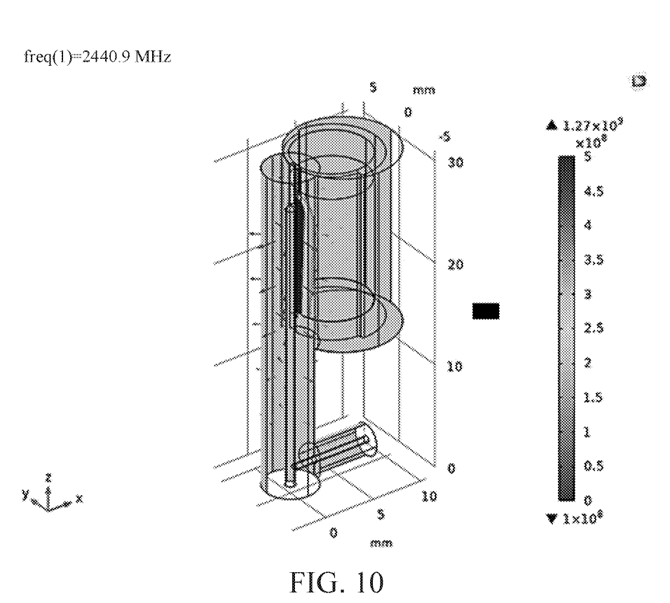

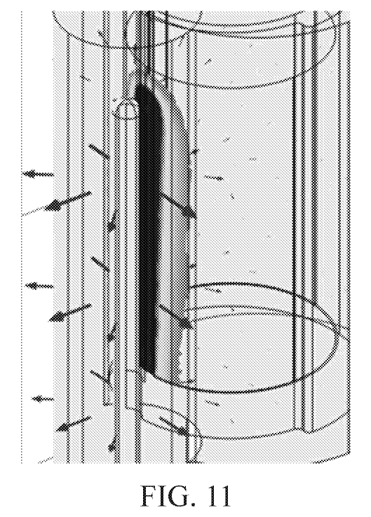

As shown in FIG. 10 to FIG. 13, compared with a conventional aerosol generating device, the aerosol generating device in this embodiment can centralize, in a particular region, the energy field inside the accommodating cavity 11 by arranging the at least two convex edges 131 on the inner surface of the outer conductor unit 10, and the distribution of the energy in the region is more uniform in the axial direction.

FIG. 14 shows a third embodiment of an aerosol generating device of the present invention, which differs from the first embodiment in that the cross section of the outer conductor unit 10 may be in a regular shape, such as a square shape, and the fixing member 30 may be directly accommodated in the accommodating cavity 11 and located on the end wall 14.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context

or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating assembly, comprising: an inner conductor unit; and an outer conductor unit comprising a closed end, an open end opposite the closed end, and an accommodating cavity formed between the closed end and the open end, an accommodating region configured to accommodate an aerosol generating product being formed inside the accommodating cavity, the accommodating cavity having a first direction and a second direction that are perpendicular to an axial direction of the aerosol generating product, the first direction being perpendicular to the second direction, wherein two convex edges protruding toward the accommodating region are arranged on an inner surface of the outer conductor unit, the two convex edges extending in a direction from the closed end to the open end, wherein the inner conductor unit is at least partially mounted inside the accommodating cavity and comprises a microwave radiation structure,
wherein, in the first direction, the microwave radiation structure is located on a same side of the accommodating region as the two convex edges,
wherein, in the second direction, the microwave radiation structure is located between the two convex edges, and wherein a minimum distance between the two convex edges on the two opposite sides of the microwave radiation structure in the second direction is less than a length of the accommodating region in the second direction.

2. The microwave heating assembly of claim 1, wherein the two convex edges extend from the closed end to the open end to a position opposite the accommodating region, or extend from a position that is away from the closed end by a set distance toward the open end to the position opposite the accommodating region.

3. The microwave heating assembly of claim 1, wherein a maximum distance between the two convex edges in the second direction is less than or equal to a length of the accommodating region in the second direction, and
wherein the maximum distance between the two convex edges in the second direction is less than or equal to 80% of the length of the accommodating region in the second direction.

4. The microwave heating assembly of claim 1, wherein the accommodating cavity comprises a first chamber configured to accommodate the aerosol generating product, and a second chamber communicated with the first chamber, and wherein the two convex edges are located on an inner surface of the first chamber.

5. The microwave heating assembly of claim 4, wherein the outer conductor unit comprises a first side wall and a second side wall that are axially connected to each other, wherein the first side wall defines the first chamber, wherein the second side wall defines the second chamber, wherein the inner conductor unit extends from the second chamber to the first chamber, wherein a microwave feeding hole is formed in the second side wall, and wherein the microwave feeding hole is communicated with the second chamber of the accommodating cavity.

6. The microwave heating assembly of claim 2, wherein an inner surface of the outer conductor unit is partially recessed so as to form a groove, wherein the groove has a notch facing the inner conductor unit, and wherein the two convex ridges are formed at the two opposite edges of the notch.

7. The microwave heating assembly of claim 1, wherein the outer conductor unit comprises a first cartridge and a second cartridge that are spliced and communicated with each other,
wherein a cross-sectional size of the first cartridge is greater than or equal to a cross-sectional size of the second cartridge,
wherein an axis of the first cartridge is parallel to an axis of the second cartridge, and
wherein the two convex ridges are formed at spliced positions of the first cartridge and the second cartridge.

8. The microwave heating assembly of claim 1, wherein the inner conductor unit comprises a microwave matching structure, wherein the microwave matching structure is disposed within the accommodating cavity, is in ohmic contact with the closed end, and extends toward the open end, the microwave radiation structure being spaced apart from the microwave matching structure and being in ohmic contact with the closed end; or, alternatively, the microwave matching structure is disposed within the accommodating cavity, is in ohmic contact with the closed end, and is coaxially connected to and integrally formed with the microwave radiation structure.

9. The microwave heating assembly of claim 1, further comprising: a fixing member disposed within the accommodating cavity and located at the open end,
wherein the fixing member is barrel-shaped, wherein a receiving cavity configured to receive the aerosol generating product is formed in the fixing member,
wherein the accommodating region is formed inside the receiving cavity, wherein the fixing member comprises a cylindrical wall, wherein a gap is provided on one side of the cylindrical wall facing the two convex edges, wherein an edge of the gap rests against an inner surface of the outer conductor unit; wherein an accommodating slot configured to accommodate at least a part of the microwave radiation structure is provided on the cylindrical wall, and wherein the accommodating slot is located on an inner side of the gap.

10. An aerosol generating device, comprising: the microwave heating assembly of claim 1; a microwave feeding unit connected to the inner conductor unit of the microwave heating assembly; and a microwave generating unit connected to the microwave feeding unit.
